(19) United States
(12) Patent Application Publication
(10) Pub. No.: US 2016/0191835 A1
(43) Pub. Date: Jun. 30, 2016

(54) REMOTE CONTROLLER

(71) Applicant: Cheng Uei Precision Industry Co., Ltd., New Taipei City (TW)

(72) Inventors: CHI MING TSENG, New Taipei City (TW); CHIA FA CHENG, New Taipei City (TW)

(21) Appl. No.: 14/585,140

(22) Filed: Dec. 29, 2014

(51) Int. Cl. H04N 5/44

(52) U.S. Cl. CPC H04N 5/4403; H04N 2005/443; H04N 2005/4405

(57) ABSTRACT

A remote controller includes a shell which includes a front shell and a back shell. A holding cavity is formed between the front shell and the back shell. A printed circuit board is fixed in the holding cavity. A mode switch button is mounted through a front face of the front shell and electrically connected to the printed circuit board. A plurality of universal buttons are mounted through the front face of the front shell. Pressing the mode switch button can make a conversion between a TV mode and a game mode. In the TV mode, the universal buttons are used as TV remote buttons; in the game mode, the universal buttons are used as game remote buttons. Therefore, the remote controller can operate in TV function, also operate in game function. It can reduce the use cost, and is convenient for users.

### BACKGROUND OF THE INVENTION

1. Field of the Invention

The present invention relates to a remote controller, and more particularly to a multifunctional remote controller.

2. The Related Art

Along with the development of modern information technology, TV (television) sets are used more and more frequently in our daily life. In order to conveniently operate the TV sets, a remote controller emerged as the times require and was used wirelessly from a short line-of-sight distance. In addition, some game enthusiasts love to play games on the TV sets, but an additional gamepad will be needed to operate the games. In view of the above, both the remote controller and the gamepad are prepared as components of the TV sets for watching TV and playing games. However, it increases the use cost, and is inconvenient to use.

Therefore, it is necessary to provide a remote controller in where functions of the gamepad are combined for reducing the use cost and facilitating the use operation.

### SUMMARY OF THE INVENTION

Accordingly, an object of the present invention is to provide a remote controller. The remote controller includes a shell which includes a front shell and a back shell. The back shell is covered on the back of the front shell. A holding cavity is formed between the front shell and the back shell. A printed circuit board is fixed in the holding cavity of the shell. A mode switch button is mounted through a front face of the front shell and electrically connected to the printed circuit board. A plurality of universal buttons are mounted through the front face of the front shell, wherein pressing the universal buttons can break corresponding electrical circuits of the printed circuit board to provide corresponding operation signals. Pressing the mode switch button can make a conversion between a TV mode and a game mode. When in the TV mode, the universal buttons are used as TV remote buttons. When in the game mode, the universal buttons are used as game remote buttons.

As described above, because the remote controller is equipped with the mode switch button, pressing the mode switch button can make a conversion between the TV mode and the game mode. In the TV mode, the universal buttons are used as the TV remote buttons; in the game mode, the universal buttons are used as the game remote buttons. Therefore, the remote controller can operate in TV function, also operate in game function. It can reduce the use cost, and is convenient for users.

### BRIEF DESCRIPTION OF THE DRAWINGS

The present invention will be apparent to those skilled in the art by reading the following description thereof, with reference to the attached drawings, in which:

FIG. 1 is a perspective view of a remote controller according to an embodiment of the present invention;

FIG. 2 is a perspective view of the remote controller without control buttons of FIG. 1;

FIG. 3 is a perspective view of a first printed circuit board and a second printed circuit board assembled in a back shell of the remote controller according to the present invention;

FIG. 4 is a cross-sectional view of the remote controller along a line IV-IV of FIG. 1;

FIG. 5 is a schematic diagram of the remote controller used in a TV mode;

FIG. 6 is a schematic diagram of the remote controller used in a game mode; and

FIG. 7 is a schematic diagram of a touch panel of the remote controller used in the game mode.

### DETAILED DESCRIPTION OF THE EMBODIMENT

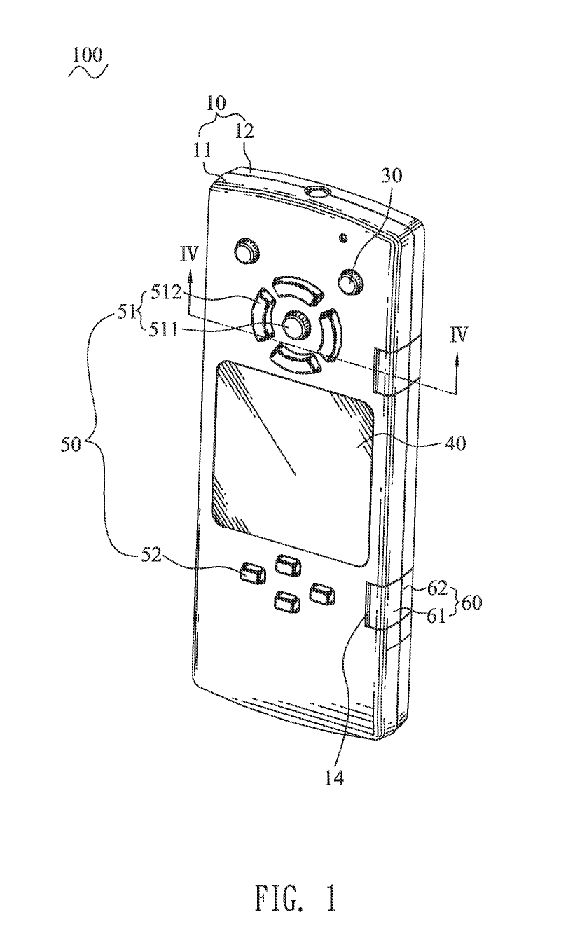

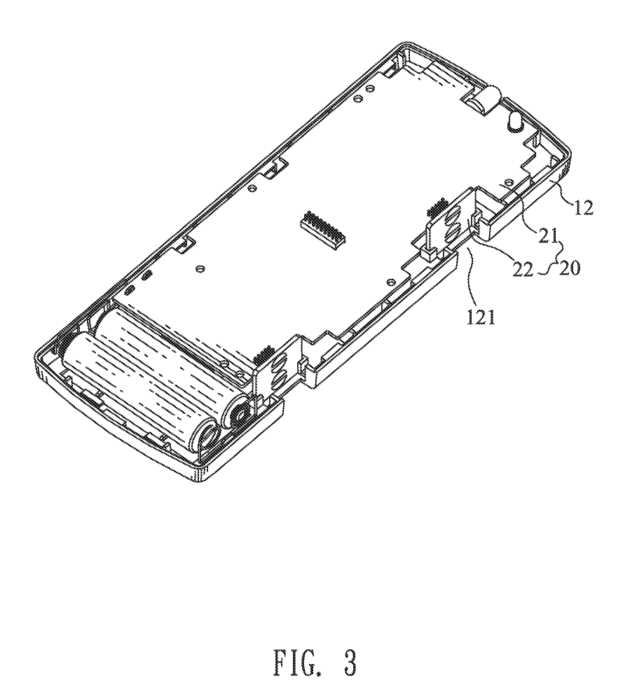

With reference to FIG. 1 and FIG. 3, an embodiment of the invention is embodied in a remote controller 100. The remote controller 100 includes a shell 10, a printed circuit board 20, a mode switch button 30, at least one touch panel 40, a plurality of universal buttons 50 and two groups of control buttons 60.

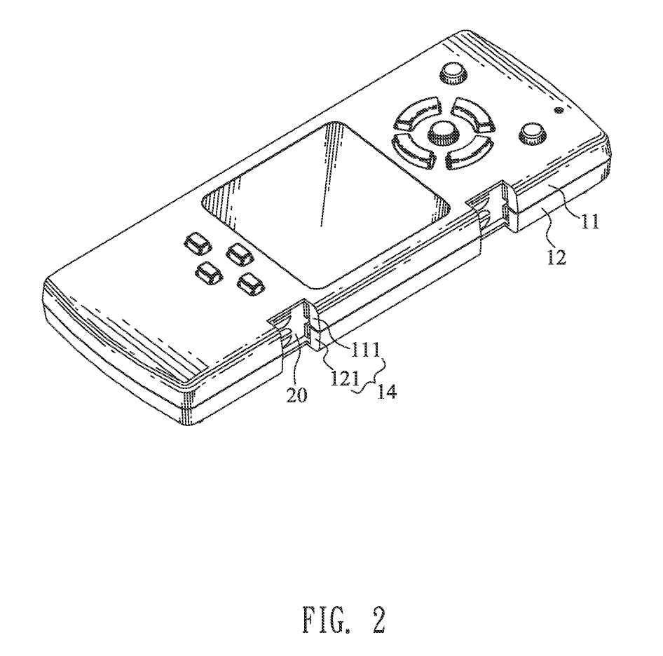

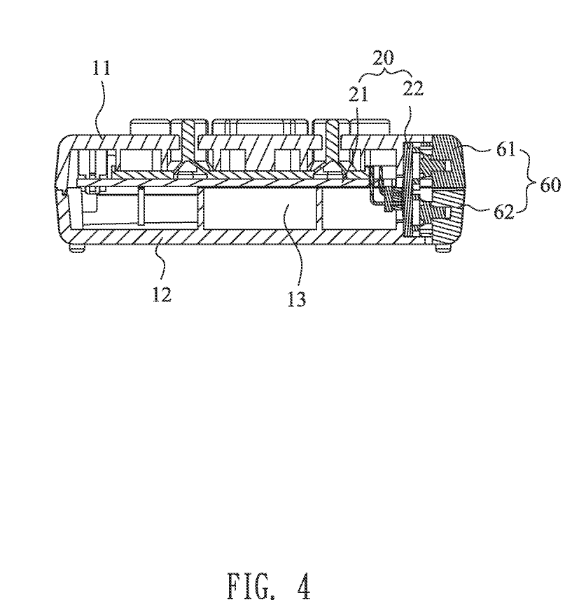

Referring to FIG. 1, FIG. 2 and FIG. 4, one side of the shell 10 defines two button gaps 14 apart from each other. The shell 10 includes a front shell 11 and a back shell 12. The back shell 12 is covered on the back of the front shell 11. A holding cavity 13 is formed between the front shell 11 and the back shell 12. One lateral side of the front shell 11 defines two first gaps 111 apart from each other. One lateral side of the back shell 12 defines two second gaps 121 apart from each other. The first gaps 111 of the front shell 11 and the second gaps 121 of the back shell 12 are aligned with each other respectively and are matched to form the two button gaps 14.

Referring to FIG. 2 to FIG. 4, the printed circuit board 20 is fixed in the holding cavity 13 of the shell 10. In detail, the printed circuit board 20 includes a first printed circuit board 21 and two second printed circuit boards 22 which are electrically connected to the first printed circuit board 21. The first printed circuit board 21 is fixed in the holding cavity 13 of the shell 10, and the first printed circuit board 21 is parallel to a front face of the front shell 11. The two second printed circuit boards 22 are fixed in the two button gaps 14 of the shell 10 and arranged perpendicular to the first printed circuit board 11 respectively. The mode switch button 30 is mounted through the front face of the front shell 11 and electrically connected to the first printed circuit board 21 of the printed circuit board 20.

Referring to FIG. 1 and FIG. 4, the touch panel 40 is a touch LCD (Liquid Crystal Display) screen. The touch panel 40 is fixed in the front face of the front shell 11 and electrically connected to the printed circuit board 20. The touch panel 40 can receive external touch operation and then transmit touch operation signals to the printed circuit board 20. The printed circuit board 20 processes the touch operation signals to control a terminal.

Referring to FIG. 1, the universal buttons 50 are mounted through the front face of the front shell 11, wherein pressing the universal buttons 50 can break corresponding electrical circuits of the printed circuit board 20 to provide corresponding operation signals. In detail, the universal buttons 50 include a plurality of first buttons 51 and a plurality of second buttons 52. The first buttons 51 are arranged on one side of the front face of the front shell 11. The first buttons 51 include a center button 511 and four direction buttons 512, wherein the direction buttons 512 are evenly arranged around the center button 511, two of the direction buttons 512 are designated as up and down direction buttons and arranged symmetrical about the center button 511, and the other two of the direction buttons 512 are designated as left and right direction buttons and arranged symmetrical about the center button 511. The second buttons 52 are arranged on the other side of the front face of the front shell 11, and the second buttons 52 are arranged in a cross shape. The mode switch button 30 and the universal buttons 50 are electrically connected to the first printed circuit board 21.

Referring to FIG. 1, FIG. 2 and FIG. 4, the two groups of control buttons 60 are apart mounted in the one lateral side of the shell 10 respectively. The second printed circuit boards 22 are located adjacent to the control buttons 60. In detail, the control buttons 60 are mounted in the button gaps 14 respectively. The control buttons 60 include two front control buttons 61 and two back control buttons 62. The front control buttons 61 are mounted in the first gaps 111 of the front shell 11 respectively, and the back control buttons 62 are mounted in the second gaps 121 of the back shell 12 respectively.

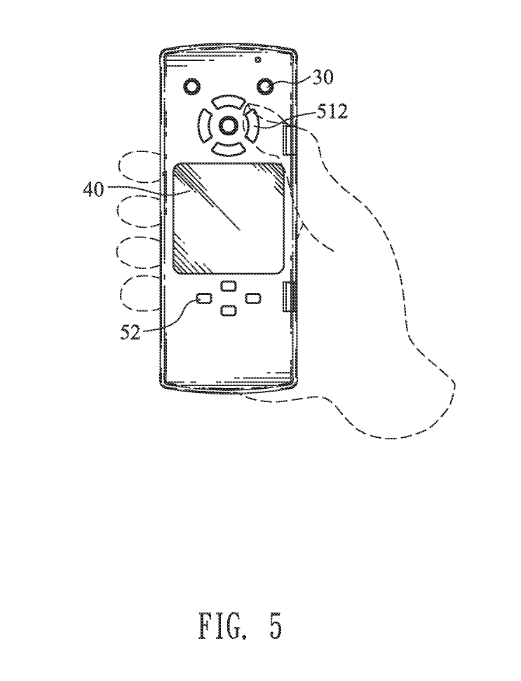

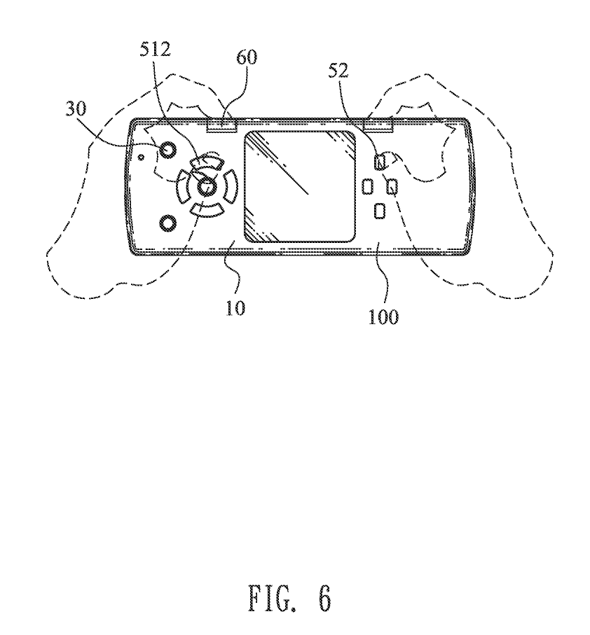

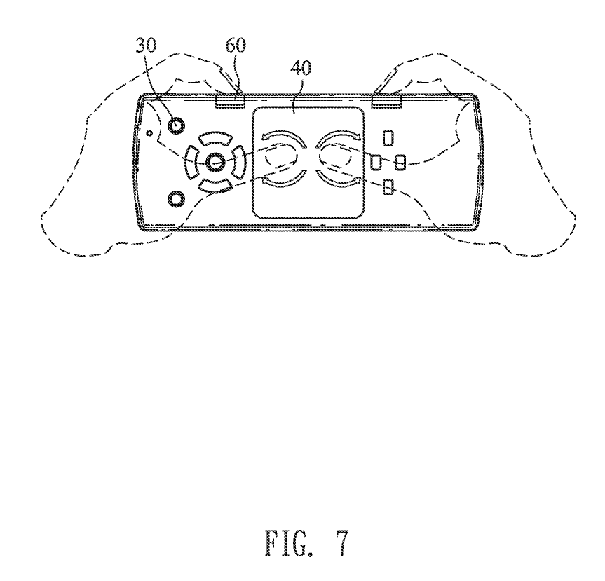

Referring to FIG. 1, FIG. 4 to FIG. 7, when the remote controller 100 is working, pressing the universal buttons 50 or the control buttons 60 can break corresponding electrical circuits of the printed circuit board 20 to provide corresponding operation signals. In detail, pressing the mode switch button 30 can make a conversion between a TV mode and a game mode. When in the TV mode, the universal buttons 50 are used as TV remote buttons. When in the game mode, all of the first buttons 51, the second buttons 52, the front control buttons 61 and the back control buttons 62 are used as game remote buttons, in detail, the front control buttons 61 and the back control buttons 62 of the control buttons 60 are pressed to trigger the second printed circuit boards 22 respectively. In addition, when in the TV mode, fingers can move and press on the touch panel 40 to control television programmes in the terminal; also in the game mode, fingers can move and press on the touch panel 40 to play games in the terminal.

As described above, because the remote controller 100 is equipped with the mode switch button 30, pressing the mode switch button 30 can make a conversion between the TV mode and the game mode. In the TV mode, the universal buttons 50 are used as the TV remote buttons, and fingers can move and press on the touch panel 40 to control the television programmes in the terminal. In the game mode, all of the first buttons 51, the second buttons 52, the front control buttons 61 and the back control buttons 62 are used as the game remote buttons, and fingers can move and press on the touch panel 40 to play games in the terminal. Therefore, the remote controller 100 can operate in TV function, also operate in game function. It can reduce the use cost, and is convenient for users.

What is claimed is:

1. A remote controller, comprising:
a shell including a front shell and a back shell, the back shell being covered on the back of the front shell, a holding cavity being formed between the front shell and the back shell;
a printed circuit board fixed in the holding cavity of the shell;
a mode switch button mounted through a front face of the front shell and electrically connected to the printed circuit board; and
a plurality of universal buttons mounted through the front face of the front shell,
wherein pressing the universal buttons can break corresponding electrical circuits of the printed circuit board to provide corresponding operation signals;
wherein pressing the mode switch button can make a conversion between a TV mode and a game mode, when in the TV mode, the universal buttons are used as TV remote buttons; when in the game mode, the universal buttons are used as game remote buttons.

2. The remote controller as claimed in claim 1, wherein the printed circuit board includes a first printed circuit board which is fixed in the holding cavity of the shell, the first printed circuit board is parallel to the front face of the front shell, the mode switch button and the universal buttons are electrically connected to the first printed circuit board.

3. The remote controller as claimed in claim 2, further comprising two groups of control buttons which are apart mounted in one lateral side the shell respectively, the printed circuit board further includes two second printed circuit boards which are fixed in the shell and arranged perpendicular to the first printed circuit board respectively, the second printed circuit boards are located adjacent to the control buttons, when the remote controller is in the game mode, the control buttons can be pressed to trigger the second printed circuit boards respectively and be used as other game remote buttons.

4. The remote controller as claimed in claim 3, wherein one lateral side of the front shell defines two first gaps apart from each other, one lateral side of the back shell defines two second gaps apart from each other, the first gaps of the front shell and the second gaps of the back shell are aligned with each other respectively and are matched to form two button gaps, the control buttons are mounted in the button gaps respectively and include two front control buttons and two back control buttons, the front control buttons are mounted in the first gaps of the front shell respectively, and the back control buttons are mounted in the second gaps of the back shell respectively.

5. The remote controller as claimed in claim 1, wherein the universal buttons include a plurality of first buttons and a plurality of second buttons, the first buttons are arranged on one side of the front face of the front shell, the second buttons are arranged on the other side of the front face of the front shell.

6. The remote controller as claimed in claim 5, wherein the first buttons include a center button and four direction buttons, the direction buttons are evenly arranged around the center button, two of the direction buttons are designated as up and down direction buttons and arranged symmetrical about the center button, the other two of the direction buttons are designated as left and right direction buttons and arranged symmetrical about the center button.

7. The remote controller as claimed in claim 5, wherein the second buttons are arranged in a cross shape.

8. The remote controller as claimed in claim 1, further comprising at least one touch panel, the touch panel is fixed in the front face of the front shell and electrically connected to the printed circuit board, the touch panel can receive external touch operation and then transmit touch operation signals to the printed circuit board, the printed circuit board processes the touch operation signals to control a terminal.

9. The remote controller as claimed in claim 8, wherein the touch panel is a touch Liquid Crystal Display screen.
